(19) United States
(12) Patent Application Publication
(10) Pub. No.: US 2021/0374821 A1
(43) Pub. Date: Dec. 2, 2021

(54) REQUIREMENT-DRIVEN SELECTION OF BUILDING PRODUCTS AND BUILDING PRODUCT CONFIGURATIONS

(71) Applicant: Oldcastle BuildingEnvelope, Inc., Plano, TX (US)

(72) Inventors: Ben West, Big Sandy, TX (US); Matt Manning, Placentia, CA (US); Erik Grobelny, Island Heights, NJ (US)

(21) Appl. No.: 17/334,859

(22) Filed: May 31, 2021

Related U.S. Application Data
(60) Provisional application No. 63/033,066, filed on Jun. 1, 2020.

(51) Int. Cl. G06Q 30/06

(52) U.S. Cl. CPC G06Q 30/0621; G06Q 30/0641

(57) ABSTRACT

A method includes receiving, via a user interface, target performance data for a building product configuration. Performance data for each of a plurality of building product configurations is automatically determined. Each of the plurality of building product configurations includes a glass product and a framing system. One or more satisfactory building product configurations are identified from the plurality building product configurations. The performance data of the one or more satisfactory building product configurations satisfies the target performance data. User-selectable configuration options are derived based, at least in part, on the one or more satisfactory building product configurations. Information related to the user-selectable configuration options is published to the user interface. A user selection of a building product configuration from the one or more satisfactory building product configurations is received.

### CROSS-REFERENCE TO RELATED APPLICATIONS

This application claims priority to, and incorporates by reference the entire disclosure of, U.S. Provisional Patent Application No. 63/033,066, filed on Jun. 1, 2020.

### TECHNICAL FIELD

The present disclosure relates generally to building products and more particularly, but not by way of limitation, to requirement-driven selection of building products and building product configurations.

### BACKGROUND

This section provides background information to facilitate a better understanding of the various aspects of the disclosure. It should be understood that the statements in this section of this document are to be read in this light, and not as admissions of prior art.

Building products can include, for example, processed, manufactured, or ready-made items that are incorporated into buildings and other structures (e.g., roads and bridges). Building products are generally made of building materials (e.g., glass, metal, wood, clay and other ceramics, soil, sand, lime, polymers (including plastics and foam), concrete, asphalt, stone, gypsum, fiberglass, fabric, composites, etc.) and may include other building products used in combination as building product configurations. Particular examples of building product configurations are glass products and metal framing systems that are used in combination for windows, doors, skylights, storefronts, entrances, curtain-wall systems, window-wall systems, combinations of the foregoing, or the like. For various building products and building product configurations involving glass materials, performance might be defined, for example, in terms of light to solar gain (LSG), relative heat gain (RHG), shading coefficient (SC), solar heat gain coefficient (SHGC), solar reflectance, solar transmittance, thermal transmittance (U-value or U-factor), ultraviolet (UV) transmittance, visible reflectance (inside), visible reflectance (outside), visible transmittance (Tvis), combinations of the foregoing, or the like.

When it comes to selection of building products and building product configurations for a building or other project, there are typically many requirements to consider. Although performance, price, size, availability, compatibility, and feasibility are often relevant requirements, there may be other requirements of interest to the person making the selection. Manually identifying all of the building products and building product configurations that satisfy all of the relevant requirements in order to make an informed selection from among them becomes increasingly burdensome and, at some point, impractical, if not impossible, as the combinations of products or configurations meeting the requirements grows. However, even computer implementation of the selection process has been technically difficult to achieve efficiently and in a way that does not presuppose a certain degree of specialized knowledge. For example, one approach has been to develop a software-based system that allows a user to select building products, for example, individual glass products, from a list, and then determines performance for the selected product, such as, for example, the system described in U.S. Pat. No. 7,257,548, which is incorporated herein by reference.

One drawback to such systems is that, even for users with specialized knowledge of, and familiarity with, building products or building product configurations, attempting to select building products or building product configurations that take into account all relevant requirements may involve an inefficient and frustrating trial-and-error process requiring multiple selections and comparisons of different products or configurations before ultimately arriving at a feasible solution, which may or may not be optimal because such a process does not ensure that all products or configurations satisfying the relevant requirements have been identified in the first place. For users lacking specialized knowledge of relevant building products or building product configurations, identifying and navigating through such selections would most likely require additional time, effort, and persistence and may still, in the end, necessitate intervention by subject matter experts. So while relying on computerized product selection processes to evaluate performance and other requirements is an improvement over manual selection processes, existing computerized selection processes, nonetheless, remain cumbersome and problematic, resulting in poor usability, sub-optimal selections, slow response times (as measured by end-to-end response times for transactions), and an overall diminished end-user experience. Network load may also be adversely impacted as a result of users repeatedly submitting multiple selections and requests for performance data, even when only a single building product or building product configuration is ultimately desired.

As another technical difficulty, many building products and building product configurations are available in standard sizes. For example, the National Fenestration Rating Council (NFRC) establishes standard sizes for various types of doors and windows. Certain users may want to deviate from the standard sizes for a particular building product or building product configuration. However, such deviations may have a substantial impact on the physical properties, price, and other attributes of the building product or building product configuration. This further complicates the above-described problem of deriving performance and other requirements from product selections because it necessitates re-calculations of performance and other data, which current systems are ill-equipped to handle, if at all. Under such circumstances, the computerized selection process is disrupted and forced to revert to manual processes. This situation limits the number of building product and building product configuration options that may be processed for consideration and significantly increases the likelihood that subject matter experts may be required, more delays may be introduced, and sub-optimal selections and mistakes may be made, all of which further diminishes the end-user's experience.

### SUMMARY

This summary is provided to introduce a selection of concepts that are further described below in the Detailed Description. This summary is not intended to identify key or essential features of the claimed subject matter, nor is it to be used as an aid in limiting the scope of the claimed subject matter.

Aspects of the disclosure relate to a method of performance-driven selection of building product configurations. The method includes receiving, via a user interface, target performance data for a building product configuration. Performance data for each of a plurality of building product configurations is automatically determined. Each of the plurality of building product configurations includes a glass product and a framing system. One or more satisfactory building product configurations are identified from the plurality building product configurations. The performance data of the one or more satisfactory building product configurations satisfies the target performance data. User-selectable configuration options are derived based, at least in part, on the one or more satisfactory building product configurations. Information related to the user-selectable configuration options is published to the user interface. A user selection of a building product configuration from the one or more satisfactory building product configurations is received.

Aspects of the disclosure relate to a method of performance-driven selection of glass products. The method includes receiving, via a user interface, target performance data for a glass product. The target performance data includes information related to at least one of an energy rating and an optical property. Performance data for each of a plurality of glass products is automatically determined. One or more satisfactory glass products is determined from the plurality of glass products. The performance data of the one or more satisfactory glass products satisfies the target performance data. User-selectable product options are derived based, at least in part, on the one or more satisfactory glass products. Information related to the user-selectable product options is published to the user interface. A user selection of a glass product from the one or more satisfactory glass products is received.

Aspects of the disclosure relate to a method of performance-driven selection of building products. The method includes receiving, via a user interface, target performance data for a building product. Performance data for each of a plurality of building products is determined. One or more satisfactory building products is determined from the plurality of building products. The performance data of the one or more satisfactory building products satisfies the target performance data. User-selectable product options are derived based, at least in part, on the one or more satisfactory building products. Information related to the user-selectable product options are published to the user interface. A user selection of a building product from the one or more satisfactory building products is received.

### BRIEF DESCRIPTION OF THE DRAWINGS

A more complete understanding of the method and apparatus of the present disclosure may be obtained by reference to the following Detailed Description when taken in conjunction with the accompanying Drawings wherein:

FIG. 1 illustrates an example of a computing environment for selection of building products and building product configurations.

FIG. 2 illustrates an example of a computer system.

FIG. 3 illustrates an example of a process for providing performance data based on glass product selections.

FIG. 4 illustrates an example of a user interface for providing performance data based on glass product selections.

FIG. 5 illustrates an example of a process for performance-driven selection of glass products.

FIG. 6 illustrates an example of a user interface for performance-driven selection of glass products.

FIG. 7 illustrates an example of a process for performance-driven selection of building product configurations.

FIG. 8 illustrates an example of a user interface for performance-driven selection of building product configurations; and

FIG. 9 illustrates an example of a user interface for reviewing and retrieving saved products and product configurations.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As used herein, the terms “comprises,” “comprising,” “includes,” “including,” “has,” “having,” or any other variation thereof, are intended to cover a non-exclusive inclusion. For example, processes, methods, articles, or apparatuses that comprise a list of elements are not necessarily limited to only those elements but may include other elements not expressly listed or inherent to such processes, methods, articles, or apparatuses. Further, unless expressly stated otherwise, the word “or” means the inclusive “or.” For example, a condition A or B is satisfied by any one of the following: A is true (or present) and B is false (or not present), A is false (or not present) and B is true (or present), both A and B are true (or present).

The present disclosure describes examples of computer-implemented, requirement-driven selection of building products and building product configurations that, in significant part, focus on performance requirements. However, those of ordinary skill in the art will appreciate that one or more requirements in addition to, or instead of, performance requirements may be used to drive selections. In various embodiments, a computer system can receive, from users, target performance data for a building product or building product configuration. In certain embodiments, the target performance data can be used to identify building products or building product configurations that satisfy the target performance data. In various embodiments, the computer system can thereafter facilitate efficient user selection of a building product or building product configuration in consideration of performance or other requirements. For example, in certain embodiments, the computer system can receive size customizations for building products or building product configurations and automatically provide revised performance data that reflects the size customizations. For illustrative purposes, examples will be described below relative to glazed systems, i.e., glass products and framing systems (e.g., metal framing systems).

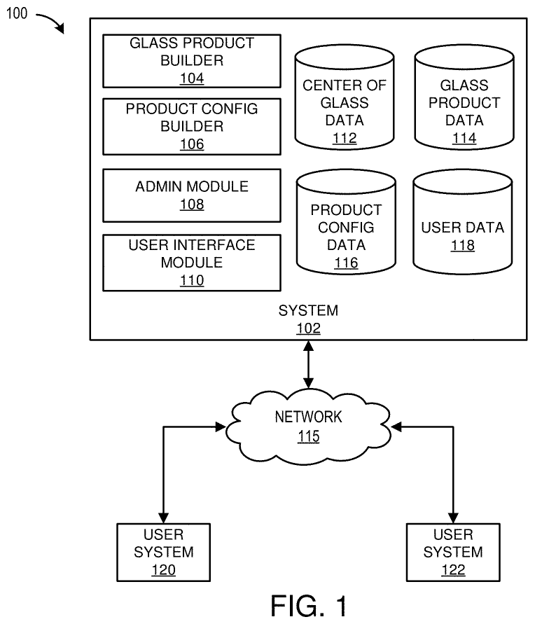

FIG. 1 illustrates an example of a computing environment 100 for selection of building products and building product configurations relating to glazed systems. The computing environment 100 includes a selection system 102, user system 120, and user system 122 that are each operable to communicate over a network 115. The network 115 may be or include a private network, a public network, a local or wide area network, a portion of the Internet, combinations of the same, or the like. The selection system 102 includes a glass product builder 104, a product configuration builder 106, an administration module 108, a user interface module 110, center of glass (COG) data 112, glass product data 114, product configuration data 116, and user data 118. In other embodiments relating to glazed systems, the selection system may also include other potentially relevant data, such as edge of glass (EOG) data.

In general, the COG data 112, the glass product data 114, the product configuration data 116, the user data 118, and other data (e.g., EOG data) can represent data stores that store any information used or generated by a component of the selection system 102. In various cases, each such data store can be, or include, a database, flat file, or the like. Advantageously, in certain embodiments, the COG data 112, the glass product data 114, the product configuration data 116, and other data can include pre-processed performance data for particular products or configurations. Particular example implementations are described below.

In an example, the COG data 112 can include a listing of generic glass products, for example, in the form of records that are primarily distinguished by COG thermal transmittance (COG U-value). In other embodiments relating to glazed systems, the data may include such a listing in the form of records that are distinguished by one or more of: COG U-value, EOG U-value, frame U-value, whole window U-value, and condensation resistance. In still other embodiments relating to glazed systems, the data may include sensitivities of the EOG U-value to one or more of: sealant height, spacer effective conductance, edge bite, and desiccant quantity. In general, the generic glass products may not correspond to an actual glass product that is available for sale, but rather provide generalized glass properties and pre-processed performance data for a given variable, for example, COG U-value. Example properties and pre-processed performance data that can be included in the COG data 112 are shown in Table 1 below.

TABLE 1

| | | | | Overall | | | | |
|---|---|---|---|---|---|---|---|---|
| | # of | | Environmental | Thickness | Uval | | | |
| Name | Layers | Tilt | Conditions | Inches | Bhu/h-ft2-F | SHGC | Tvis | Tdw-ISO |
| COG-0-44 | 2 | 90 | NFRC 100-2010 | 0.947 | 0.440 | 0.684 | 0.738 | 0.598 |
| COG-0-42 | 2 | 90 | NFRC 100-2010 | 0.961 | 0.420 | 0.345 | 0.325 | 0.301 |
| COG-0-40 | 2 | 90 | NFRC 100-2010 | 0.948 | 0.400 | 0.236 | 0.167 | 0.159 |
| COG-0-38 | 2 | 90 | NFRC 100-2010 | 0.961 | 0.380 | 0.210 | 0.147 | 0.117 |
| COG-0-36 | 2 | 90 | NFRC 100-2010 | 0.961 | 0.360 | 0.206 | 0.147 | 0.117 |
| COG-0-34 | 2 | 90 | NFRC 100-2010 | 0.955 | 0.340 | 0.177 | 0.127 | 0.114 |
| COG-0-32 | 2 | 90 | NFRC 100-2010 | 0.955 | 0.320 | 0.173 | 0.127 | 0.114 |
| COG-0-28 | 2 | 90 | NFRC 100-2010 | 0.958 | 0.280 | 0.439 | 0.533 | 0.488 |
| COG-0-26 | 2 | 90 | NFRC 100-2010 | 0.948 | 0.260 | 0.388 | 0.702 | 0.530 |
| COG-0-24 | 2 | 90 | NFRC 100-2010 | 0.946 | 0.240 | 0.366 | 0.628 | 0.431 |
| COG-0-22 | 2 | 90 | NFRC 100-2010 | 0.946 | 0.220 | 0.250 | 0.525 | 0.312 |
| COG-0-20 | 2 | 90 | NFRC 100-2010 | 0.946 | 0.200 | 0.249 | 0.525 | 0.312 |
| COG-0-18 | 3 | 90 | NFRC 100-2010 | 0.951 | 0.180 | 0.247 | 0.567 | 0.356 |
| COG-0-16 | 3 | 90 | NFRC 100-2010 | 0.949 | 0.160 | 0.234 | 0.463 | 0.267 |
| COG-0-14 | 3 | 90 | NFRC 100-2010 | 0.949 | 0.140 | 0.228 | 0.463 | 0.267 |
| COG-0-12 | 3 | 90 | NFRC 100-2010 | 0.949 | 0.120 | 0.227 | 0.463 | 0.267 |
| COG-0-10 | 3 | 90 | NFRC 100-2010 | 0.949 | 0.100 | 0.225 | 0.463 | 0.267 |

In an example, the glass product data 114 can include a listing of specific glass products, for example, in the form of records that are identified by a product identifier, name, or other key. In contrast to the COG data 112, the specific glass products in the glass product data may correspond to actual glass products that are available for sale. In that way, the glass product data 114 can include physical properties of the specific glass products as well as pre-processed performance data of the specific glass products. Example properties and pre-processed performance data that can be included in the glass product data 114 are shown in Table 2 below.

TABLE 2

| | | | | Overall | | | | |
|---|---|---|---|---|---|---|---|---|
| | # of | | Environmental | Thickness | Uval | | | Tdw- |
| Name | Layers | Tilt | Conditions | Inches | Bhu/h-ft2-F | SHGC | Tvis | ISO |
| CLR/AIR/CLR | 2 | 90 | NFRC 100-2010 | 0.946 | 0.474 | 0.703 | 0.791 | 0.074 |
| (6 MM/6 MM) - 1″ IG_CL | | | | | | | | |
| z75/AIR/CLR | 2 | 90 | NFRC 100-2010 | 0.946 | 0.285 | 0.227 | 0.465 | 0.337 |
| (6 MM/6 MM) - 1″ IG_CL | | | | | | | | |
| z75/ARG90/CLR | 2 | 90 | NFRC 100-2010 | 0.946 | 0.238 | 0.218 | 0.465 | 0.337 |
| (6 MM/6 MM) - 1″ IG_CL | | | | | | | | |
| S860/AIR/CLR | 2 | 90 | NFRC 100-2010 | 0.946 | 0.291 | 0.391 | 0.704 | 0.533 |
| (6 MM/6 MM) - 1″ IG_CL | | | | | | | | |
| S860/ARG90/CLR | 2 | 90 | NFRC 100-2010 | 0.946 | 0.245 | 0.386 | 0.704 | 0.533 |
| (6 MM/6 MM) - 1″ IG_CL | | | | | | | | |
| S870/AIR/CLR | 2 | 90 | NFRC 100-2010 | 0.946 | 0.285 | 0.274 | 0.644 | 0.431 |
| (6 MM/6 MM) - 1″ IG_CL | | | | | | | | |
| S870/ARG90/CLR | 2 | 90 | NFRC 100-2010 | 0.946 | 0.238 | 0.269 | 0.644 | 0.431 |
| (6 MM/6 MM) - 1″ IG_CL | | | | | | | | |
| SN68/AIR/CLR | 2 | 90 | NFRC 100-2010 | 0.942 | 0.292 | 0.377 | 0.679 | 0.554 |
| (6 MM/6 MM) - 1″ IG_CL | | | | | | | | |
| SN68/ARG90/CLR | 2 | 90 | NFRC 100-2010 | 0.942 | 0.246 | 0.373 | 0.679 | 0.554 |
| (6 MM/6 MM) - 1″ IG_CL | | | | | | | | |
| SN54/AIR/CLR | 2 | 90 | NFRC 100-2010 | 0.942 | 0.288 | 0.285 | 0.544 | 0.392 |
| (6 MM/6 MM) - 1″ IG_CL | | | | | | | | |
| SN54/ARG90/CLR | 2 | 90 | NFRC 100-2010 | 0.942 | 0.242 | 0.279 | 0.544 | 0.392 |
| (6 MM/6 MM) - 1″ IG_CL | | | | | | | | |
| S890/AIR/CLR | 2 | 90 | NFRC 100-2010 | 0.946 | 0.287 | 0.234 | 0.510 | 0.357 |
| (6 MM/6 MM) - 1″ IG_CL | | | | | | | | |
| S890/ARG90/CLR | 2 | 90 | NFRC 100-2010 | 0.946 | 0.240 | 0.227 | 0.510 | 0.357 |
| (6 MM/6 MM) - 1″ IG_CL | | | | | | | | |
| SNX62/27/AIR/CLR | 2 | 90 | NFRC 100-2010 | 0.942 | 0.286 | 0.267 | 0.617 | 0.394 |
| (6 MM/6 MM) - 1″ IG_CL | | | | | | | | |
| SNX62/27/ARG90/CLR | 2 | 90 | NFRC 100-2010 | 0.942 | 0.239 | 0.262 | 0.617 | 0.394 |
| (6 MM/6 MM) - 1″ IG_CL | | | | | | | | |
| SNX51/23/AIR/CLR | 2 | 90 | NFRC 100-2010 | 0.942 | 0.286 | 0.233 | 0.509 | 0364 |
| (6 MM/6 MM) - 1″ IG_CL | | | | | | | | |
| SNX51/23/ARG90/CLR | 2 | 90 | NFRC 100-2010 | 0.942 | 0.239 | 0.226 | 0.509 | 0.364 |
| (6 MM/6 MM) - 1″ IG_CL | | | | | | | | |
| SNR43/AIR/CLR | 2 | 90 | NFRC 100-2010 | 0.942 | 0.288 | 0.228 | 0.430 | 0.350 |
| (6 MM/6 MM) - 1″ IG_CL | | | | | | | | |
| SNR43/ARG90/CLR | 2 | 90 | NFRC 100-2010 | 0.942 | 0.241 | 0.222 | 0.430 | 0.350 |
| (6 MM/6 MM) - 1″ IG_CL | | | | | | | | |
| SBR100/AIR/CLR | 2 | 90 | NFRC 100-2010 | 0.946 | 0.291 | 0.233 | 0.415 | 0.336 |
| (6 MM/6 MM) - 1″ IG_CL | | | | | | | | |
| SBR100/ARG90/CLR | 2 | 90 | NFRC 100-2010 | 0.946 | 0.245 | 0.227 | 0.415 | 0.336 |
| (6 MM/6 MM) - 1″ IG_CL | | | | | | | | |

In an example, the product configuration data 116 can include a listing of specific compatible configurations of glass products and metal framing systems, in the form of records, that are primarily distinguished by the particular combination of glass product(s) and framing system(s) which form each configuration. In various embodiments, the configurations of the product configuration data 116 can involve generic glass products from the data, such as the COG data 112, or specific glass products from the glass product data 114. In a typical embodiment, the product configuration data 116 reflect pre-established compatibilities between products. Example metal framing systems that can be included in the configurations of the product configuration data are shown in Table 3 below. Example properties and pre-processed performance data that can be included for each configuration in the product configuration data 116 are shown in Table 4 below.

TABLE 3
Name

6000XT-HD-WE_CLR-AIR-CLR (6 MM-6 MM)-1-IG_CL.thm
6000XT-JL-WE_CLR-AIR-CLR (6 MM-6 MM)-1-IG_CL.thm
6000XT-JR-WE_CLR-AIR-CLR (6 MM-6 MM)-1-IG_CL.thm
6000XT-SL-WE_CLR-AIR-CLR (6 MM-6 MM)-1-IG_CL.thm
6000XT-HD-WE_z75-AIR-CLR (6 MM-6 MM)-1-IG_CL.thm
6000XT-JL-WE_z75-AIR-CLR (6 MM-6 MM)-1-IG_CL.thm
6000XT-JR-WE_z75-AIR-CLR (6 MM-6 MM)-1-IG_CL.thm
6000XT-SL-WE_z75-AIR-CLR (6 MM-6 MM)-1-IG_CL.thm
6000XT-HD-WE_z75-ARG90-CLR (6 MM-6 MM)-1-IG_CL.thm
6000XT-JL-WE_z75-ARG90-CLR (6 MM-6 MM)-1-IG_CL.thm
6000XT-JR-WE_z75-ARG90-CLR (6 MM-6 MM)-1-IG_CL.thm
6000XT-SL-WE_z75-ARG90-CLR (6 MM-6 MM)-1-IG_CL.thm
6000XT-HD-WE_SB60-AIR-CLR (6 MM-6 MM)-1-IG_CL.thm
6000XT-JL-WE_SB60-AIR-CLR (6 MM-6 MM)-1-IG_CL.thm
6000XT-JR-WE_SB60-AIR-CLR (6 MM-6 MM)-1-IG_CL.thm
6000XT-SL-WE_SB60-AIR-CLR (6 MM-6 MM)-1-IG_CL.thm
6000XT-HD-WE_SB70-AIR-CLR (6 MM-6 MM)-1-IG_CL.thm
6000XT-JL-WE_SB70-AIR-CLR (6 MM-6 MM)-1-IG_CL.thm
6000XT-JR-WE_SB70-AIR-CLR (6 MM-6 MM)-1-IG_CL.thm
6000XT-SL-WE_SB70-AIR-CLR (6 MM-6 MM)-1-IG_CL.thm
6000XT-HD-WE_SB70-ARG90-CLR (6 MM-6 MM)-1-IG_CL.thm
6000XT-JL-WE_SB70-ARG90-CLR (6 MM-6 MM)-1-IG_CL.thm
6000XT-JR-WE_SB70-ARG90-CLR (6 MM-6 MM)-1-IG_CL.thm
6000XT-SL-WE_SB70-ARG90-CLR (6 MM-6 MM)-1-IG_CL.thm
6000XT-HD-WE_SN68-AIR-CLR (6 MM-6 MM)-1-IG_CL.thm
6000XT-JL-WE_SN68-AIR-CLR (6 MM-6 MM)-1-IG_CL.thm
6000XT-JR-WE_SN68-AIR-CLR (6 MM-6 MM)-1-IG_CL.thm

TABLE 4

| | | | | Height | Ufactor | | | |
|---|---|---|---|---|---|---|---|---|
| ID | Name | Type | Width | Inches | Bhu/h-ft2-F | SHGC | Tvis | CR |
| 1 | 6000XT CLR- | Custom | 39.37 | 78.74 | 0.524 | 0.645 | 0.724 | 42.6 |
| | AIR-CLR-WE | Single | | | | | | |
| | | W | | | | | | |
| 2 | 6000XT z75- | Custom | 39.37 | 78.74 | 0.363 | 0.210 | 0.425 | 50.6 |
| | AIR-CLR-WE | Single | | | | | | |
| | | W | | | | | | |
| 3 | 6000XT z75- | Custom | 39.37 | 78.74 | 0.323 | 0.203 | 0.425 | 52.8 |
| | ARG-CLR-WE | Single | | | | | | |
| | | W | | | | | | |
| 4 | 6000XT S860- | Custom | 39.37 | 78.74 | 0.368 | 0.360 | 0644 | 50.3 |
| | AIR-CLR-WE | Single | | | | | | |
| | | W | | | | | | |
| 5 | 6000XT S860- | Custom | 39.37 | 78.74 | 0.335 | 0.356 | 0.644 | 50.3 |
| | ARG-CLR-WE | Single | | | | | | |
| | | W | | | | | | |
| 6 | 6000XT S870- | Custom | 39.37 | 78.74 | 0.363 | 0.254 | 0.589 | 50.6 |
| | AIR-CLR-WE | Single | | | | | | |
| | | W | | | | | | |
| 7 | 6000XT S870- | Custom | 39.37 | 78.74 | 0.323 | 0.249 | 0.589 | 52.8 |
| | ARG-CLR-WE | Single | | | | | | |
| | | W | | | | | | |
| 8 | 6000XT SN68- | Custom | 39.37 | 78.74 | 0.369 | 0.348 | 0.622 | 50.2 |
| | AIR-CLR-WE | Single | | | | | | |
| | | W | | | | | | |
| 9 | 6000XT SN68- | Custom | 39.37 | 78.74 | 0.330 | 0.344 | 0.622 | 52.4 |
| | ARG-CLR-WE | Single | | | | | | |
| | | W | | | | | | |
| 10 | 6000XT SN54- | Custom | 39.37 | 78.74 | 0.306 | 0.264 | 0.496 | 50.4 |
| | AIR-CLR-WE | Single | | | | | | |
| | | W | | | | | | |
| 11 | 6000XT SN54- | Custom | 39.37 | 78.74 | 0.326 | 0.258 | 0.496 | 52.6 |
| | ARG-CLR-WE | Single | | | | | | |
| | | W | | | | | | |
| 12 | 6000XT S890- | Custom | 39.37 | 78.74 | 0.365 | 0.217 | 0.467 | 50.5 |
| | AIR-CLR-WE | Single | | | | | | |
| | | W | | | | | | |
| 13 | 6000XT S890- | Custom | 39.37 | 78.74 | 0.325 | 0.211 | 0.467 | 52.7 |
| | ARG-CLR-WE | Single | | | | | | |
| | | W | | | | | | |
| 14 | 6000XT | Custom | 39.37 | 78.74 | 0.364 | 0.248 | 0.565 | 50.5 |
| | 5ND/62/27- | Single | | | | | | |
| | AIR-CLR-WE | W | | | | | | |
| 15 | 6000XT | Custom | 39.37 | 78.74 | 0.324 | 0.242 | 0.565 | 52.7 |
| | 5ND/62/27- | Single | | | | | | |
| | ARG-CLR-WE | W | | | | | | |
| 16 | 6000XT | Custom | 39.37 | 78.74 | 0.364 | 0.216 | 0.466 | 50.5 |
| | SND/51/23- | Single | | | | | | |
| | AIR-CLR-WE | W | | | | | | |
| 17 | 6000XT | Custom | 39.37 | 78.74 | 0.324 | 0.210 | 0.466 | 52.7 |
| | SND/51/23- | Single | | | | | | |
| | ARG-CLR-WE | W | | | | | | |
| 18 | 6000XT | Custom | 39.37 | 78.74 | 0.365 | 0.211 | 0.394 | 50.4 |
| | 5NR43-AIR- | Single | | | | | | |
| | CLR-WE | W | | | | | | |
| 19 | 6000XT | Custom | 39.37 | 78.74 | 0.326 | 0.206 | 0.394 | 52.6 |
| | 5NR43-ARG- | Single | | | | | | |
| | CLR-WE | W | | | | | | |
| 20 | 6000XT | Custom | 39.37 | 78.74 | 0.368 | 0.216 | 0.380 | 50.3 |
| | 58R100-AIR- | Single | | | | | | |
| | CLR-WE | W | | | | | | |
| 21 | 6000XT | Custom | 39.37 | 78.74 | 0.329 | 0.211 | 0.380 | 52.5 |
| | S8R100-ARG- | Single | | | | | | |
| | CLR-WE | W | | | | | | |

In general, the user data 118 can include any data generated or created by a user of the selection system 102 or by the selection system 102 in its interaction with the user. For example, the user data 118 can include saved glass products from the COG data 112 or the glass product data 114. By way of further example, the user data 118 can include saved configurations from the product configuration data 116. In other examples, the user data 118 can include customizations of the COG data 112, the glass product data 114, or the product configuration data 116, as well as any resulting performance data or other data. In addition, or alternatively, the user data 118 can save data regarding the user's session with the selection system 102. In still other examples, user data may be used as training data to identify relationships in user selections and other activities within the system that can be encoded in an artificial intelligence (AI) model, such as a neural network or other machine learning algorithm. Such AI models may be used to determine user preferences and requirements, so as to make recommendations and return results that may further streamline and otherwise improve the selection process.

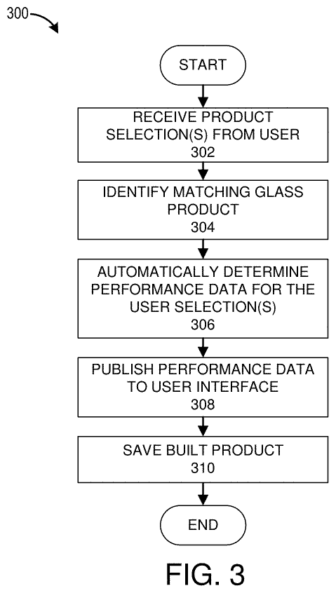

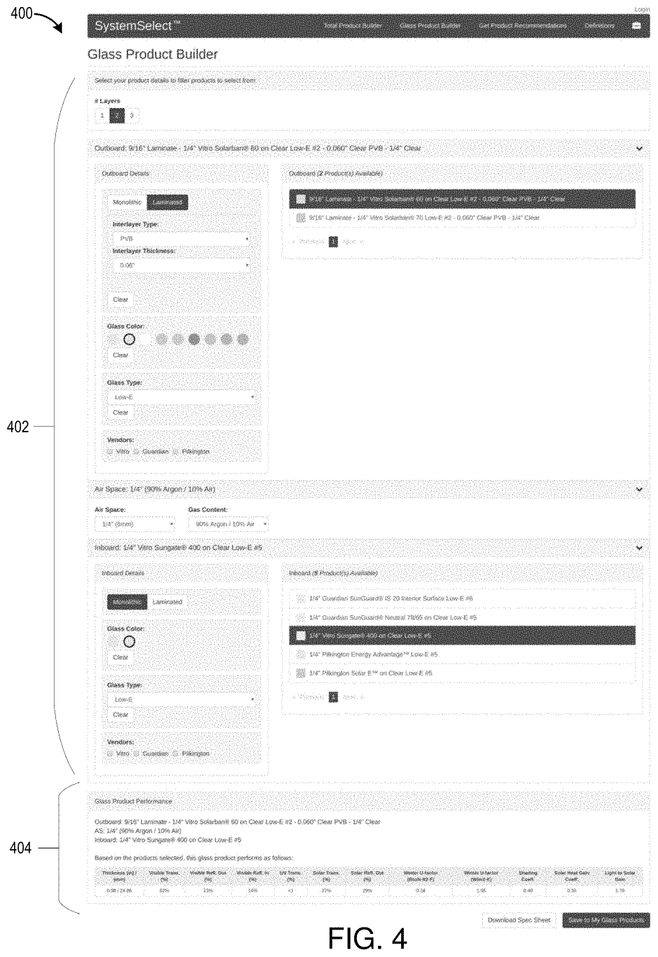

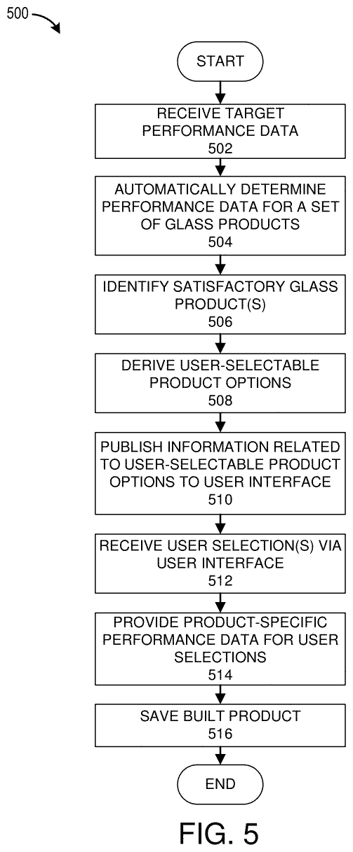

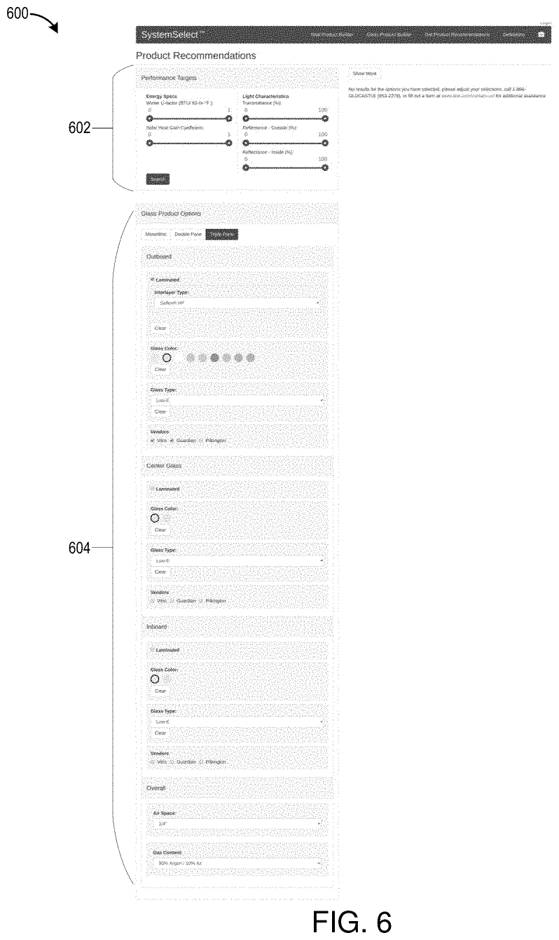

The glass product builder 104 can build and configure glass products using the COG data 112 or the glass product data 114. In various embodiments, the glass product builder 104 can leverage the COG data 112 or the glass product data 114 for the benefit of users from multiple data perspectives. In an example, the glass product builder 104 can enable a product-based data perspective, where the glass product builder 104 identifies glass products based on user input and provides performance data for the identified glass products. Examples of providing performance data for identified glass products will be described in relation to FIGS. 3-4. In another example, the glass product builder 104 can enable a performance-based perspective, where the glass product builder 104 identifies performance targets of a user, in the form of target performance data, and provides information related to glass products that satisfy the performance targets. Examples of performance-driven selection of glass products will be described in relation to FIGS. 5-6.

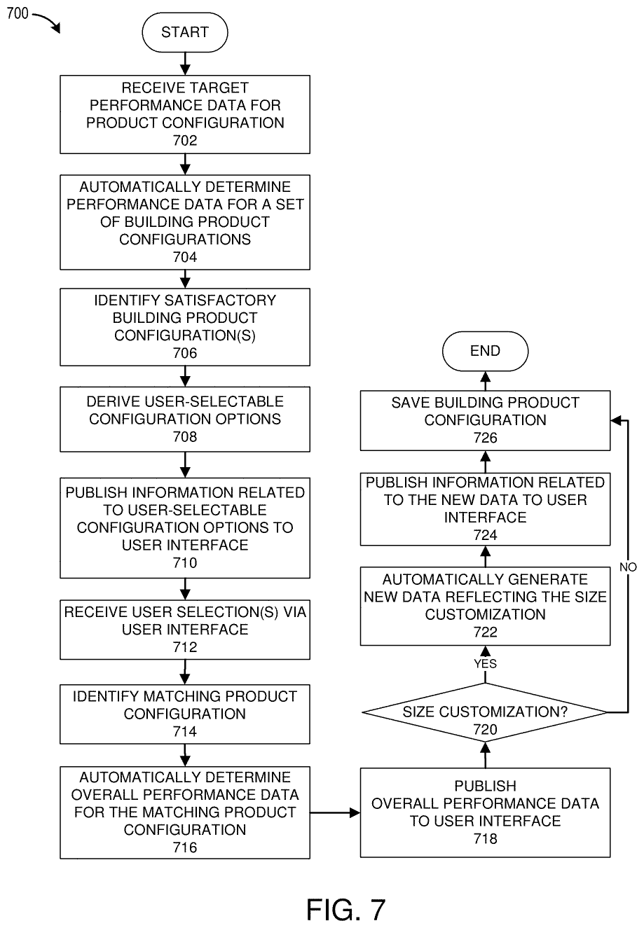

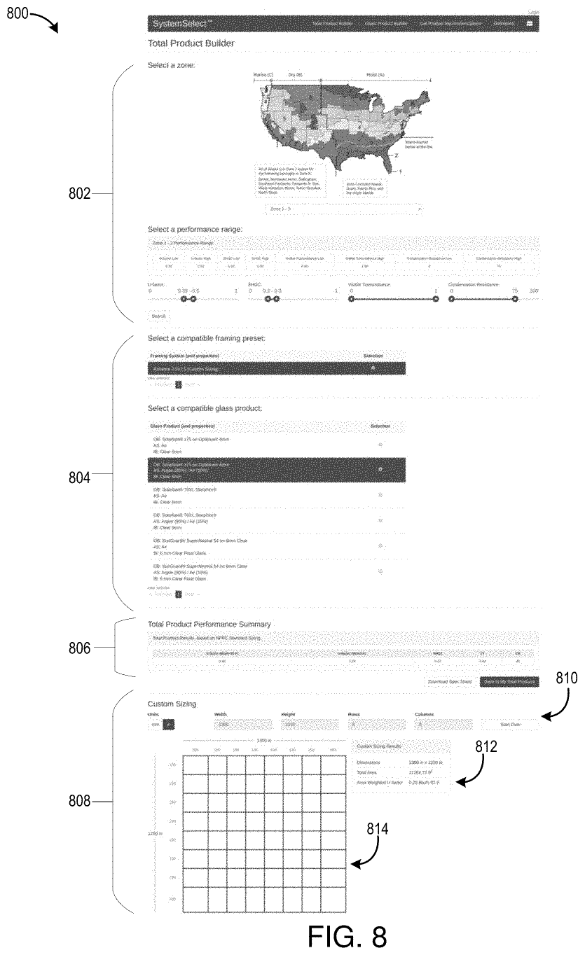

The product configuration builder 106 can build product configurations using the product configuration data 116. In various embodiments, the product configuration builder 106, in similar fashion to the glass product builder 104, can leverage the product configuration data 116 for the benefit of users from multiple data perspectives. In an example, the product configuration builder 106 can enable a configuration-based data perspective, where the product configuration builder 106 makes data related to product configurations available for viewing and access. In another example, the product configuration builder 106 can enable a performance-based perspective, where the product configuration builder 106 identifies performance targets of a user, in the form of target performance data, and facilitates selection of product configurations that satisfy the performance targets. Furthermore, in various embodiments, the product configuration builder 106 can enable user-indicated size customizations, and then provide performance data, such as revised performance property data, and other data based thereon. Example operation of the product configuration builder 106 will be described in relation to FIGS. 7-8.

The user interface module 110 can serve an interface or dashboard to users, for example, of the user system 120 or the user system 122, for purposes of triggering or interacting with the glass product builder 104 or the product configuration builder 106. The administration module 108 can serve as an interface to administrators, superusers, or other appropriate users for purposes of administering the selection system 102. In some embodiments, administrators, via the user system 120 or the user system 122, can access a web interface, an application programming interface (API) or other interface of the selection system 102 for purposes of performing administration functionality. In some embodiments, the COG data 112, the glass product data 114 or the product configuration data 116 can be updated via the administration module 108.

The user system 120 and the user system 122 can each be a computer system usable to access the selection system 102. Although two user systems are shown for illustrative purposes, it should be appreciated that the computing environment 100 can include any number of user systems. The user system 120 and the user system 122 can each be a computer system such as a smartphone, a wearable or body-borne computer, a desktop computer, a laptop computer, a tablet computer, a personal digital assistant (PDA), combinations of same or the like. In certain embodiments, the user system 120 and the user system 122 are examples of computer systems that can be user-operated to use or administer the selection system 102.

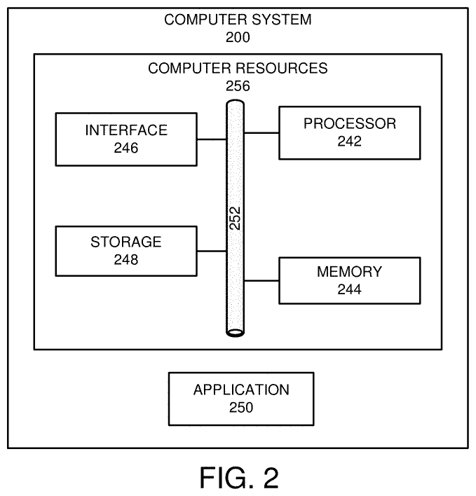

FIG. 2 illustrates an example of a computer system 200 that, in some cases, can be representative, for example, of the selection system 102, the user system 120, or the user system 122. The computer system 200 includes an application 250 operable to execute on computer resources 256. The application 250 can be similar, for example, to the glass product builder 104, the product configuration builder 106, the administration module 108, or the user interface module 110. In particular embodiments, the computer system 200 may perform one or more steps of one or more methods described or illustrated herein. In particular embodiments, one or more computer systems may provide functionality described or illustrated herein. In particular embodiments, encoded software running on one or more computer systems may perform one or more steps of one or more methods described or illustrated herein or provide functionality described or illustrated herein.

The components of the computer system 200 may comprise any suitable physical form, configuration, number, type and/or layout. As an example, and not by way of limitation, the computer system 200 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a wearable or body-borne computer, a server, or a combination of two or more of these. Where appropriate, the computer system 200 may include one or more computer systems; be unitary or distributed; span multiple locations; span multiple machines; or reside in a cloud, which may include one or more cloud components in one or more networks.

In the depicted embodiment, the computer system 200 includes a processor 242, memory 244, storage 248, interface 246, and bus 252. Although a particular computer system is depicted having a particular number of particular components in a particular arrangement, this disclosure contemplates any suitable computer system having any suitable number of any suitable components in any suitable arrangement.

Processor 242 may be a microprocessor, controller, or any other suitable computing device, resource, or combination of hardware, software and/or encoded logic operable to execute, either alone or in conjunction with other components, (e.g., memory 244), the application 250. Such functionality may include providing various features discussed herein. In particular embodiments, processor 242 may include hardware for executing instructions, such as those making up the application 250. As an example and not by way of limitation, to execute instructions, processor 242 may retrieve (or fetch) instructions from an internal register, an internal cache, memory 244, or storage 248; decode and execute them; and then write one or more results to an internal register, an internal cache, memory 244, or storage 248.

In particular embodiments, processor 242 may include one or more internal caches for data, instructions, or addresses. This disclosure contemplates processor 242 including any suitable number of any suitable internal caches, where appropriate. As an example and not by way of limitation, processor 242 may include one or more instruction caches, one or more data caches, and one or more translation lookaside buffers (TLBs). Instructions in the instruction caches may be copies of instructions in memory 244 or storage 248 and the instruction caches may speed up retrieval of those instructions by processor 242. Data in the data caches may be copies of data in memory 244 or storage 248 for instructions executing at processor 242 to operate on; the results of previous instructions executed at processor 242 for access by subsequent instructions executing at processor 242, or for writing to memory 244, or storage 248; or other suitable data. The data caches may speed up read or write operations by processor 242. The TLBs may speed up virtual-address translations for processor 242. In particular embodiments, processor 242 may include one or more internal registers for data, instructions, or addresses. Depending on the embodiment, processor 242 may include any suitable number of any suitable internal registers, where appropriate. Where appropriate, processor 242 may include one or more arithmetic logic units (ALUs); be a multi-core processor; include one or more processors 242; or any other suitable processor.

Memory 244 may be any form of volatile or non-volatile memory including, without limitation, magnetic media, optical media, random access memory (RAM), read-only memory (ROM), flash memory, removable media, or any other suitable local or remote memory component or components. In particular embodiments, memory 244 may include random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM, or any other suitable type of RAM or memory. Memory 244 may include one or more memories 244, where appropriate. Memory 244 may store any suitable data or information utilized by the computer system 200, including software embedded in a computer readable medium, and/or encoded logic incorporated in hardware or otherwise stored (e.g., firmware). In particular embodiments, memory 244 may include main memory for storing instructions for processor 242 to execute or data for processor 242 to operate on. In particular embodiments, one or more memory management units (MMUs) may reside between processor 242 and memory 244 and facilitate accesses to memory 244 requested by processor 242.

As an example and not by way of limitation, the computer system 200 may load instructions from storage 248 or another source (such as, for example, another computer system) to memory 244. Processor 242 may then load the instructions from memory 244 to an internal register or internal cache. To execute the instructions, processor 242 may retrieve the instructions from the internal register or internal cache and decode them. During or after execution of the instructions, processor 242 may write one or more results (which may be intermediate or final results) to the internal register or internal cache. Processor 242 may then write one or more of those results to memory 244. In particular embodiments, processor 242 may execute only instructions in one or more internal registers or internal caches or in memory 244 (as opposed to storage 248 or elsewhere) and may operate only on data in one or more internal registers or internal caches or in memory 244 (as opposed to storage 248 or elsewhere).

In particular embodiments, storage 248 may include mass storage for data or instructions. As an example and not by way of limitation, storage 248 may include a hard disk drive (HDD), a floppy disk drive, flash memory, an optical disc, a magneto-optical disc, magnetic tape, or a Universal Serial Bus (USB) drive or a combination of two or more of these. Storage 248 may include removable or non-removable (or fixed) media, where appropriate. Storage 248 may be internal or external to the computer system 200, where appropriate. In particular embodiments, storage 248 may be non-volatile, solid-state memory. In particular embodiments, storage 248 may include read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. Storage 248 may take any suitable physical form and may comprise any suitable number or type of storage. Storage 248 may include one or more storage control units facilitating communication between processor 242 and storage 248, where appropriate.

In particular embodiments, interface 246 may include hardware, encoded software, or both providing one or more interfaces for communication (such as, for example, packet-based communication) among any networks, any network devices, or any other computer systems. As an example and not by way of limitation, communication interface 246 may include a network interface controller (NIC) or network adapter for communicating with an Ethernet or other wire-based network or a wireless NIC (WNIC) or wireless adapter for communicating with a wireless network.

Depending on the embodiment, interface 246 may be any type of interface suitable for any type of network for which computer system 200 is used. As an example and not by way of limitation, computer system 200 can include (or communicate with) an ad-hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 can include (or communicate with) a wireless PAN (WPAN) (such as, for example, a BLUETOOTH WPAN), a WI-FI network, a WI-MAX network, an LTE network, an LTE-A network, a cellular telephone network (such as, for example, a Global System for Mobile Communications (GSM) network), or any other suitable wireless network or a combination of two or more of these. The computer system 200 may include any suitable interface 246 for any one or more of these networks, where appropriate.

In some embodiments, interface 246 may include one or more interfaces for one or more I/O devices. One or more of these I/O devices may enable communication between a person and the computer system 200. As an example and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these. An I/O device may include one or more sensors. Particular embodiments may include any suitable type and/or number of I/O devices and any suitable type and/or number of interfaces 246 for them. Where appropriate, interface 246 may include one or more drivers enabling processor 242 to drive one or more of these I/O devices. Interface 246 may include one or more interfaces 246, where appropriate.

Bus 252 may include any combination of hardware, software embedded in a computer readable medium, or encoded logic incorporated in hardware or otherwise stored (e.g., firmware) to couple components of the computer system 200 to each other. As an example and not by way of limitation, bus 252 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 252 may include any number, type, or configuration of buses 252, where appropriate. In particular embodiments, one or more buses 252 (which may each include an address bus and a data bus) may couple processor 242 to memory 244. Bus 252 may include one or more memory buses.

Herein, reference to a computer-readable storage medium encompasses one or more tangible computer-readable storage media possessing structures. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a flash memory card, a flash memory drive, or any other suitable tangible computer-readable storage medium or a combination of two or more of these, where appropriate.

Particular embodiments may include one or more computer-readable storage media implementing any suitable storage. In particular embodiments, a computer-readable storage medium implements one or more portions of processor 242 (such as, for example, one or more internal registers or caches), one or more portions of memory 244, one or more portions of storage 248, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody encoded software.

Herein, reference to encoded software may encompass one or more applications, bytecode, one or more computer programs, one or more executables, one or more instructions, logic, machine code, one or more scripts, or source code, and vice versa, where appropriate, that have been stored or encoded in a computer-readable storage medium. In particular embodiments, encoded software includes one or more application programming interfaces (APIs) stored or encoded in a computer-readable storage medium. Particular embodiments may use any suitable encoded software written or otherwise expressed in any suitable programming language or combination of programming languages stored or encoded in any suitable type or number of computer-readable storage media. In particular embodiments, encoded software may be expressed as source code or object code. In particular embodiments, encoded software is expressed in a higher-level programming language, such as, for example, C, C++, FORTRAN, Pascal, Perl, Python, or a suitable extension thereof. In particular embodiments, encoded software is expressed in a lower-level programming language, such as assembly language (or machine code). In particular embodiments, encoded software is expressed in JAVA. In particular embodiments, encoded software is expressed in Hyper Text Markup Language (HTML), Extensible Markup Language (XML), or other suitable markup language.

FIGS. 3-4 illustrate examples of providing performance data based on glass product selections. More particularly, FIG. 3 illustrates an example of a process 300 for providing performance data based on glass product selections, and FIG. 4 illustrates an example of a user interface 400 for providing performance data based on glass product selections. The process 300 can be implemented by any system that can process data. In some cases, the process 300 can be performed generally by the selection system 102 or the computing environment 100 of FIG. 1. Although the process 300 can be performed by any number of computer systems or components and can utilize a variety of different user interfaces, illustrative operation of the process 300 will be described relative to particular components of the selection system 102 and the user interface 400 of FIG. 4.

At block 302, the glass product builder 104 receives glass product selections from a user, for example, of the user system 120 or the user system 122, via a user interface served thereto. In general, the glass product selections can include one or more selections sufficient to identify a particular glass product or a configuration thereof. In various embodiments, the block 302 can occur progressively, with the glass product builder 104 sequentially providing additional selection options in response to previous user selections, so as to drill down to selections sufficient to identify the particular glass product. For example, with reference to FIG. 4, glass product selections 402 can be received via the user interface 400.

At block 304, the glass product builder 104 identifies a matching glass product based on the glass product selections received from the user. In various embodiments, the matching glass product can be, for example, a generic product in the COG data 112 or a specific product in the glass product data 114. In some cases, the block 304 can involve, for example, the glass product builder 104 executing a query on the COG data 112 or the glass product data 114, where the query yields the matching glass product.

At block 306, the glass product builder 104 automatically determines performance data for the matching glass product from the block 304. As described previously, the COG data 112 or the glass product data 114 can include pre-processed performance data for the glass products identified therein. In some of these embodiments, the block 306 can involve the glass product builder 104 accessing and retrieving pre-processed performance data for the matching glass product in the COG data 112 or the glass product data 114, as appropriate. In some cases, accessing and retrieving the pre-processed performance data can increase transaction speed and improve an end-user experience, since delays are not introduced for computations or for intervention of subject matter experts. In addition, or alternatively, the glass product builder 104 can automatically compute some or all of the performance data on-demand. In some of these implementations, the glass product builder 104 can use in-built business rules and calculations to compute at least a portion of the performance data. In some embodiments, the glass product builder 104 can interact with a third-party component via an interface to receive at least a portion of the performance data.

At block 308, the glass product builder 104 publishes information related to the generated performance data to the user interface. For example, the glass product builder 104 can publish some or all of the performance data from the block 306 to the user interface. For example, with reference to FIG. 4, performance data 404 can be published to the user interface 400.

At block 310, the glass product builder 104 saves a user-built product, corresponding to the matching glass product from the block 304, to the user data 118. In some cases, the block 310 can include saving some or all performance data resulting from the block 306. In some embodiments, the glass product builder 104 may only save the user-built product in response to a user instruction to do so. In such cases, the block 310 can be performed only when instructed to do so by the user. In some embodiments, the block 310 can be omitted, such that user-built products are not saved. After block 310, the process 300 ends.

FIGS. 5-6 illustrate examples of performance-driven selection of glass products. More particularly, FIG. 5 illustrates an example of a process 500 for performance-driven selection of glass products, and FIG. 6 illustrates an example of a user interface 600 for performance-driven selection of glass products. The process 500 can be implemented by any system that can process data. In some cases, the process 500 can be performed generally by the selection system 102 or the computing environment 100 of FIG. 1. Although the process 500 can be performed by any number of computer systems or components and can utilize a variety of different user interfaces, illustrative operation of the process 500 will be described relative to particular components of the selection system 102 and the user interface 600 of FIG. 6.

At block 502, the glass product builder 104 receives target performance data from a user, for example, of the user system 120 or the user system 122, via a user interface. In a typical embodiment, the target performance data refers to desired performance of a glass product that has not yet been specifically selected or identified by the user. For example, the target performance data can relate to an energy specification or rating, optical properties indicative of how a given glass product interacts with light, an acoustic specification or rating, combinations of the foregoing, or the like. In most cases, the target performance data includes performance values or value ranges that can be compared across products. In an example, with reference to FIG. 6, target performance data 602 can be received via the user interface 600.

At block 504, the glass product builder 104 automatically determines performance data for a set of glass products. In various embodiments, the set can include all glass products for which information is available to the selection system 102 (including information that is imported or otherwise accessible or available from third-party sources), all glass products in a given dataset such as the COG data 112 or the glass product data 114, a subset of glass products in any of the foregoing, user or client-specific sets of glass products, combinations or subsets of the foregoing, or the like. As described previously, the COG data 112 or the glass product data 114 can include pre-processed performance data for the glass products identified therein. In some of these embodiments, the block 504 can involve the glass product builder 104 accessing and retrieving pre-processed performance data for the set of glass products, for example, from the COG data 112 or the glass product data 114, as appropriate. In some cases, accessing and retrieving the pre-processed performance data can increase transaction speed and improve an end-user experience, since delays are not introduced for computations or for intervention of subject matter experts. In addition, or alternatively, the glass product builder 104 can automatically compute some or all of the performance data on-demand. In some of these implementations, the glass product builder 104 can use in-built business rules and calculations to compute at least a portion of the performance data. In some embodiments, the glass product builder 104 can interact with a third-party component via an interface to receive at least a portion of the performance data.

At block 506, the glass product builder 104 identifies satisfactory glass products using the performance data from the block 504. In general, the satisfactory glass products can correspond to glass products in the set which satisfy the target performance data, as evidenced by the performance data from the block 504. At block 508, the glass product builder 104 derives user-selectable product options given the satisfactory glass products from the block 506. The user-selectable product options can generally correspond to any user choices, for example, with regard to physical glass properties, that are permitted within the satisfactory glass products.

At block 510, the glass product builder 104 publishes information related to the user-selectable product options to the user interface. At block 512, the glass product builder 104 receives glass product selections from the user via the user interface. In general, the glass product selections can include one or more selections sufficient to identify a particular glass product or a configuration thereof within the satisfactory glass products from the block 506. In various embodiments, the blocks 510 and 512 can occur progressively, with the glass product builder 104 sequentially providing additional selection options in response to previous user selections, so as to drill down to selections sufficient to identify the particular glass product. For example, with reference to FIG. 6, glass product selections 604 can be received via the user interface 600.

At block 514, the glass product builder 104 provides product-specific performance data based on the glass product selections received at the block 512. In general, the block 514 can include the glass product builder 104 executing actions similar to those described with respect to blocks 304, 306, and 308 of the process 300 of FIG. 3. In certain embodiments, such as those in which no product-specific performance data needs to be published to the user interface, the block 514 can be omitted.

At block 516, the glass product builder 104 saves a user-built product, corresponding to the glass product selections from the block 512, to the user data 118. In some cases, the block 516 can include saving some or all performance data resulting from the block 514. In some embodiments, the glass product builder 104 may only save the user-built product in response to a user instruction to do so. In such cases, the block 516 can be performed only when instructed to do so by the user. In some embodiments, the block 516 can be omitted, such that user-built products are not saved. After block 516, the process 500 ends.

FIGS. 7-8 illustrate examples of performance-driven selection of glass products. More particularly, FIG. 7 illustrates an example of a process 700 for performance-driven selection of building product configurations, and FIG. 8 illustrates an example of a user interface 800 for performance-driven selection of building product configurations. The process 700 can be implemented by any system that can process data. In some cases, the process 700 can be performed generally by the selection system 102 or the computing environment 100 of FIG. 1. Although the process 700 can be performed by any number of computer systems or components and can utilize a variety of different user interfaces, illustrative operation of the process 700 will be described relative to particular components of the selection system 102 and the user interface 800 of FIG. 8.

At block 702, the product configuration builder 106 receives target performance data from a user, for example, of the user system 120 or the user system 122, via a user interface. In a typical embodiment, the target performance data refers to desired performance of a building product configuration that has not yet been specifically selected or identified by the user. In the example of FIGS. 7-8, the building product configuration is assumed to be a configuration involving a combination of one or more glass products and one or more metal framing systems, although it should be appreciated that the principles described herein are not so limited. For example, the target performance data can relate to an energy specification or rating, optical properties indicative of how a glass component of a given configuration interacts with light, an acoustic specification or rating, combinations of the foregoing, or the like. In most cases, the target performance data includes performance values or value ranges that can be compared across product configurations. In some embodiments, the block 702 can involve the product configuration builder 106 receiving a user indication of a geographic region or zone, which the product configuration builder 106 automatically resolves to the performance values or ranges. In an example, with reference to FIG. 8, target performance data 802 can be received via the user interface 800.

At block 704, the product configuration builder 106 automatically determines performance data for a set of building product configurations. In various embodiments, the set can include all building product configurations for which information is available to the selection system 102 (including information that is imported or otherwise accessible or available from third-party sources), all building product configurations in a given dataset such as the product configuration data 116, a subset of building product configurations in any of the foregoing, user or client-specific sets of building product configurations, combinations or subsets of the foregoing, or the like. As described previously, the product configuration data 116 can include pre-processed performance data for the building product configurations identified therein. In some of these embodiments, the block 704 can involve the product configuration builder 106 accessing and retrieving pre-processed performance data for the set of building product configurations, for example, from the product configuration data 116. In some cases, accessing and retrieving the pre-processed performance data can increase transaction speed and improve an end-user experience, since delays are not introduced for computations or for intervention of subject matter experts. In addition, or alternatively, the product configuration builder 106 can automatically compute some or all of the performance data on-demand. In some of these implementations, the product configuration builder 106 can use in-built business rules and calculations to compute at least a portion of the performance data. In some embodiments, the product configuration builder 106 can interact with a third-party component via an interface to receive at least a portion of the performance data.

At block 706, the product configuration builder 106 identifies satisfactory product configurations using the performance data from the block 704. In general, the satisfactory product configurations can correspond to product configurations in the set which satisfy the target performance data, as evidenced by the performance data from the block 704. At block 708, the product configuration builder 106 derives user-selectable configuration options given the satisfactory product configurations from the block 706. The user-selectable product configurations can generally correspond to any user choices, for example, with regard to glass products, framing systems or physical properties that are permitted within the satisfactory product configurations.

At block 710, the product configuration builder 106 publishes information related to the user-selectable configuration options to the user interface. At block 712, the product configuration builder 106 receives product configuration selections from the user via the user interface, where the production configuration selections constitute a user-selected product configuration from the satisfactory product configurations. In general, the product configuration selections can include one or more selections sufficient to identify a particular product configuration within the satisfactory product configurations identified at the block 706.

In various embodiments, the blocks 710 and 712 can occur progressively, with the product configuration builder 106 sequentially providing additional selection options in response to previous user selections, so as to drill down to selections sufficient to identify the particular product configuration. In an example, the blocks 710 or 712 could include the product configuration builder 106 receiving a user selection of a framing system and then identifying, from the satisfactory product configurations identified at the block 706, product configurations that include the user-selected framing system. Continuing this example, the product configuration builder 106 could thereafter provide to the user, or publish to the user interface, information identifying satisfactory glass products given the user-selected framing system. For purposes of this example, the satisfactory glass products could correspond to all glass products represented in the subset of product configurations that include the user-selected framing system. According to this example, the product configuration builder 106 could receive a user selection of one of the satisfactory glass products (or potentially more than one). In this example, the product configuration selections could include, or be defined by, the user-selected framing system and the user-selected glass product. In a more particular example, FIG. 8 illustrates receipt of product configuration selections 804 via the user interface 800.

In another example, the blocks 710 or 712 could include the product configuration builder 106 receiving a user selection of a glass product and then identifying, from the satisfactory product configurations identified at the block 706, product configurations that include the user-selected glass product. Continuing this example, the product configuration builder 106 could thereafter provide to the user, or publish to the user interface, information identifying satisfactory framing systems given the user-selected glass product. For purposes of this example, the satisfactory framing systems could correspond to all framing systems represented in the subset of product configurations that include the user-selected glass product. According to this example, the product configuration builder 106 could receive a user selection of one of the satisfactory framing systems (or potentially more than one). In this example, the product configuration selections could include, or be defined by, the user-selected glass product and the user-selected framing system.

At block 714, the product configuration builder 106 identifies a matching product configuration based on the product configuration selections received from the user, where the matching product configuration is the user-selected product configuration. In a typical embodiment, the matching product configuration corresponds and maps to one of the satisfactory product configurations from the block 706. In some cases, the block 714 can involve, for example, the product configuration builder 106 executing a query on the product configuration data 116, where the query yields the matching product configuration.

At block 716, the product configuration builder 106 automatically determines overall performance data for the matching product configuration from the block 714. In some embodiments, the overall performance data can be retrieved, for example, from the performance data which was determined at the block 704. In addition, or alternatively, some or all of the overall performance data can be retrieved from pre-processed performance data in the product configuration data 116. In addition, or alternatively, the product configuration builder 106 can automatically compute some or all of the overall performance data on-demand. In some of these implementations, the product configuration builder 106 can use in-built business rules and calculations to compute at least a portion of the performance data. In some embodiments, the product configuration builder 106 can interact with a third-party component via an interface to receive at least a portion of the overall performance data.

At block 718, the product configuration builder 106 publishes information related to the overall performance data to the user interface. For example, the product configuration builder 106 can publish some or all of the overall performance data from the block 716 to the user interface. For example, with reference to FIG. 8, overall performance data 806 can be published to the user interface 800.

At decision block 720, the product configuration builder 106 determines whether a size customization has been received from the user via the user interface. In various embodiments, the user interface can include a customization interface that allows the user to perform size customizations and view resultant performance data and other data. For example, with reference to FIG. 8, the user interface 800 includes a customization interface 808. If it is determined at the decision block that no size customization has been received, the process 700 proceeds to block 726. In some embodiments, the user interface may not include a customization interface. In these embodiments, the process 700 may likewise proceed to the block 726. Otherwise, if it is determined at the decision block 720 that a size customization has been received, the process 700 proceeds to block 722. In an example, with reference to FIG. 8, a size customization 810 can be received via the user interface 800.

At block 722, the product configuration builder 106 automatically generates new data reflecting the size customization. In an example, the block 722 can include the product configuration builder 106 generating a visualization reflecting new dimensions as specified in the size customization. In another example, the block 722 can include the product configuration builder 106 generating new performance data such as, for example, an area-weighted U-factor according to a new area calculation resulting from the size customization. At block 724, the product configuration builder 106 publishes information related to the new data to the user interface. For example, with reference to FIG. 8, new performance data 812 and a visualization 814 can be published to the user interface 800.

At block 726, the product configuration builder 106 saves a user-built product configuration, for example, to the user data 118. In some embodiments, the block 726 can involve saving the matching product configuration from the block 714 without customization. In addition, or alternatively, if customization occurred as a result of the blocks 720-722, the block 726 can involve saving the matching product configuration as customized. In some cases, the block 726 can include saving some or all performance data resulting from the block 716 or 722. In some embodiments, the product configuration builder 106 may only save the user-built product configuration in response to a user instruction to do so. In such cases, the block 726 can be performed only when instructed to do so by the user. In some embodiments, the block 726 can be omitted, such that user-built product configurations are not saved. After block 726, the process 700 ends.

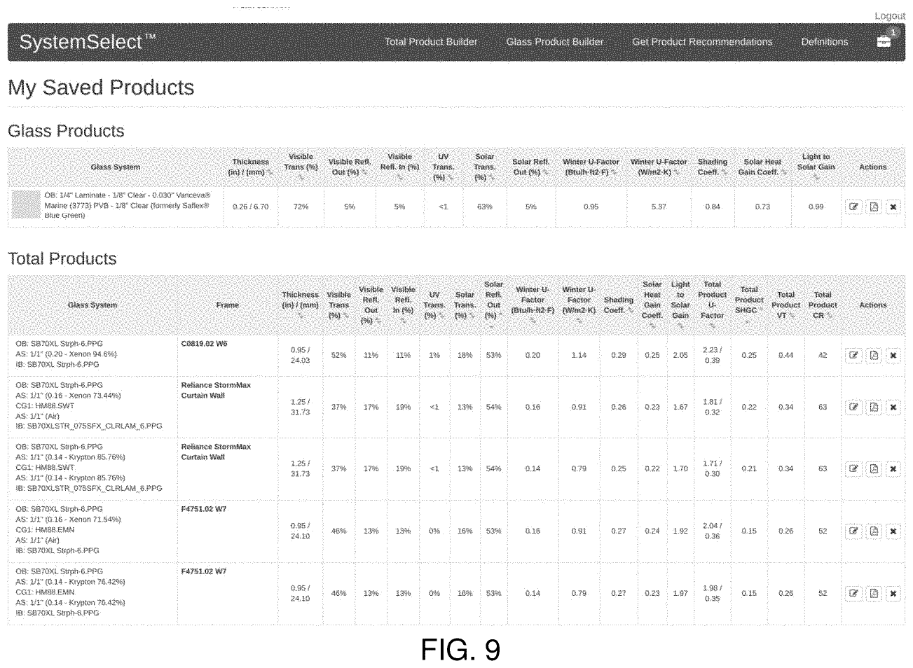

FIG. 9 illustrates an example of an interface for reviewing and retrieving saved products and product configurations.

Depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. Although certain computer-implemented tasks are described as being performed by a particular entity, other embodiments are possible in which these tasks are performed by a different entity.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

What is claimed is:

1. A method of performance-driven selection of building product configurations comprising, by a computer system:
receiving, via a user interface, target performance data for a building product configuration;
automatically determining performance data for each of a plurality of building product configurations, wherein each of the plurality of building product configurations includes a glass product and a framing system;
identifying, from the plurality building product configurations, one or more satisfactory building product configurations, wherein the performance data of the one or more satisfactory building product configurations satisfies the target performance data;
deriving user-selectable configuration options based, at least in part, on the one or more satisfactory building product configurations;
publishing, to the user interface, information related to the user-selectable configuration options; and
receiving a user selection of a building product configuration from the one or more satisfactory building product configurations.

2. The method of claim 1, comprising:
automatically determining overall performance data for the user-selected building product configuration; and
publishing the overall performance data to the user interface.

3. The method of claim 1, comprising:
receiving, via the user interface, a size customization in relation to the user-selected building product configuration;
automatically generating new data reflecting the size customization; and
publishing the new data to the user interface.

4. The method of claim 3, wherein the new data comprises a visualization reflecting the size customization.

5. The method of claim 3, wherein the new data comprises new performance data reflecting the size customization.

6. The method of claim 5, wherein the new performance data comprises an area-weighted U-factor.

7. The method of claim 1, wherein the receiving a user selection of a building product configuration comprises:
receiving a user selection of a framing system;
identifying, from the one or more satisfactory building product configurations, at least one building product configuration that includes the user-selected framing system;
publishing, to the user interface, information related to a glass product included in each of the at least one building product configuration; and
receiving a user selection of the glass product of at least one of the at least one building product configuration, wherein the user-selected building product configuration comprises the user-selected framing system and the user-selected glass product.

8. The method of claim 1, wherein the automatically determining performance data comprises accessing pre-processed performance data for at least some of the plurality of building product configurations.

9. The method of claim 1, wherein the target performance data comprises an energy rating.

10. The method of claim 1, wherein the automatically determining performance data comprises calculating at least a portion of the performance data.

11. The method of claim 1, wherein the glass product included in the user-selected building product configuration comprises a generic glass product identified by center of glass.

12. A method of performance-driven selection of glass products comprising, by a computer system:
receiving, via a user interface, target performance data for a glass product, wherein the target performance data comprises information related to at least one of an energy rating and an optical property;
automatically determining performance data for each of a plurality of glass products;
identifying, from the plurality of glass products, one or more satisfactory glass products, wherein the performance data of the one or more satisfactory glass products satisfies the target performance data;
deriving user-selectable product options based, at least in part, on the one or more satisfactory glass products;
publishing, to the user interface, information related to the user-selectable product options; and
receiving a user selection of a glass product from the one or more satisfactory glass products.

13. The method of claim 12, comprising:
automatically determining overall performance data for the user-selected glass product; and
publishing the overall performance data to the user interface.

14. The method of claim 12, wherein the automatically determining performance data comprises accessing pre-processed performance data for at least some of the plurality of glass products.

15. The method of claim 12, wherein the automatically determining performance data comprises calculating at least a portion of the performance data.

16. The method of claim 12, wherein the glass product included in the user-selected glass product comprises a generic glass product identified by center of glass.

17. A method of performance-driven selection of building products comprising, by a computer system:
receiving, via a user interface, target performance data for a building product;
automatically determining performance data for each of a plurality of building products;
identifying, from the plurality of building products, one or more satisfactory building products, wherein the performance data of the one or more satisfactory building products satisfies the target performance data;
deriving user-selectable product options based, at least in part, on the one or more satisfactory building products;
publishing, to the user interface, information related to the user-selectable product options; and
receiving a user selection of a building product from the one or more satisfactory building products.

18. The method of claim 17, comprising:
automatically determining overall performance data for the user-selected building products; and
publishing the overall performance data to the user interface.

19. The method of claim 17, comprising:
receiving, via the user interface, a size customization in relation to the user-selected building products;
automatically generating new data reflecting the size customization; and
publishing the new data to the user interface.

20. The method of claim 17, wherein the receiving a user selection of a building product comprises:
receiving a user selection of a framing system;
identifying, from the one or more satisfactory building products, at least one building product that includes the user-selected framing system;
publishing, to the user interface, information related to the glass product included in each of the at least one building products; and
receiving a user selection of the glass product of at least one of the at least one building products, wherein the user-selected building products comprises the user-selected framing system and the user-selected glass product.
